(19) United States
(12) Patent Application Publication
(10) Pub. No.: US 2026/0145942 A1
(43) Pub. Date: May 28, 2026

(54) METHOD FOR MANUFACTURING COMPOSITE ELECTRODE PARTICLES COATED WITH GRANULAR SILICON STRUCTURE, CARBON LAYER AND ZINC OXIDE

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen (CN)

(21) Appl. No.: 18/963,562

(22) Filed: Nov. 28, 2024

(51) Int. Cl. C01B 32/05

(52) U.S. Cl. CPC C01B 32/05; C01P 2002/08; C01P 2004/61; C01P 2004/84; C01P 2006/40

(57) ABSTRACT

A method for manufacturing composite electrode particles coated with a granular silicon structure, a carbon layer and zinc oxide includes the steps of: placing plural first silicon particles, a macromolecule material, a bitumen and an alcohol solution into a grinding mill for mixing to cause that a part of the first silicon particles form plural composite silicon particles; then placing plural porous carbon particles into the grinding mill for mixing to form a first mixture; then placing the first mixture into a rotary evaporator to obtain plural mixture powders; then placing the mixture powders into a sintering furnace for performing an atmosphere sintering to obtain plural first composite particles coated with the carbon layer having the first silicon particles and composite silicon particles; and then placing plural zinc oxide particles and the first composite particles into a roller mixer for mixing to obtain the composite electrode particles.

### FIELD OF THE INVENTION

The present invention is related to battery electrode material, and in particular to a method for manufacturing composite electrode particles coated with a granular silicon structure, a carbon layer and zinc oxide.

### BACKGROUND OF THE INVENTION

A typical battery includes a positive electrode and a negative electrode. The negative electrode of a solid-state or semi-solid battery includes a negative electrode substrate and a negative electrode slurry layer. The negative electrode slurry layer includes a negative electrode slurry and a plurality of negative electrode particles. The negative electrode particles must be either additionally conductive or electrically conductive to allow free electrons to migrate through the negative electrode slurry without consuming too much energy due to internal resistance.

The negative electrode particles are dispersed within the negative electrode slurry and an outer surface of each negative electrode particle is coated with silicon particles. In the chemical reaction of the battery, the lithium ions will enter into the silicon particles to expand the size of the silicon particle, wherein the expanded size may be up to 400 times the original size of the silicon particle. Therefore, the size of the negative electrode particles will change dramatically, and such a large size expansion will break down the electrode particles, resulting in a degradation of the battery's performance.

### SUMMARY OF THE INVENTION

Accordingly, for improving above mentioned defects in the prior art, the object of the present invention is to provide a method for manufacturing composite electrode particles coated with a granular silicon structure, a carbon layer and zinc oxide, wherein the carbon layer with the silicon particles is coated on the outer surface of the porous carbon particle. The silicon particles coated with the silicon oxide layer has a lower coefficient of thermal expansion and has a high binding ability, which inhibits the expansion of the composite electrode particle to prevent the composite electrode particle from rupturing. The carbon layer has a high conductivity and serves to inhibit an expansion of the composite electrode particle to prevent the composite electrode particle from rupturing due to a volumetric expansion when the lithium ions fill on the composite electrode particle. The outer side of the carbon layer is further coated with the zinc oxide layer which has a high conductivity and has the ductility identical to that of metals. When the lithium ions fill the silicon particles and expand the size of the silicon particles, the zinc oxide layer serves to protect the structure inside by the high ductility. As a result, by above multi-layer coating structure, the breakage rate of composite electrode particle can be greatly reduced.

To achieve above object, the present invention provides a method for manufacturing composite electrode particles coated with a granular silicon structure, a carbon layer and zinc oxide comprising the steps of: step A: placing a plurality of first silicon particles, a macromolecule material, a bitumen and an alcohol solution into a grinding mill for mixing and grinding; wherein in the mixing and grinding of the grinding mill, a part of the first silicon particles performs a disproportionation to form a plurality of composite silicon particles; each of the composite silicon particles includes a respective one first silicon particle and a silicon oxide layer formed by SiOₓ, wherein 0<x≤2; and the silicon oxide layer is formed through the disproportionation and is coated on an outer surface of the respective first silicon particle; step B: placing a plurality of porous carbon particles into the grinding mill for continuous mixing and grinding with the first silicon particles, the macromolecule material, the bitumen and the alcohol solution to form a first mixture; and wherein each of the porous carbon particles has a plurality of holes to receive the first silicon particles expanded; step C: taking out the first mixture after the mixing and grinding from the grinding mill, and then placing the first mixture into a rotary evaporator for removing the alcohol solution to obtain a plurality of mixture powders; step D: placing the mixture powders into a sintering furnace for performing an atmosphere sintering on the mixture powders to cause that the porous carbon particles forms a plurality of first composite particles; wherein in the atmosphere sintering, an outer surface of each of the porous carbon particles is coated with the carbon layer formed by the macromolecule material and the bitumen; the carbon layer includes a plurality of corresponding first silicon particles and a plurality of corresponding composite silicon particles; each of the porous carbon particles coated with the carbon layer forms a respective one first composite particle; the first silicon particles and the composite silicon particles on each of the first composite particles form a discontinuous structure, wherein in each of the first composite particles, the first silicon particles and the composite silicon particles on an outer side of the corresponding carbon layer form an island-shaped structure having plural protruded portions, the first silicon particles and the composite silicon particles on an inner side of the corresponding carbon layer are attached on the outer surface of the corresponding porous carbon particle, and the first silicon particles and the composite silicon particles between the outer side and the inner side of the corresponding carbon layer are suspended in the corresponding carbon layer without contacting the corresponding porous carbon particle; step E: placing a plurality of zinc oxide particles and the first composite particles into a roller mixer for mixing to cause that an outer surface of each of the first composite particles is coated with a zinc oxide layer formed by the zinc oxide particles; wherein the first composite particles coated with the zinc oxide layer form the composite electrode particles; and the zinc oxide particles on each of the first composite particles form an island-shaped structure having plural protruded portions; and wherein the silicon oxide layer serves to inhibit an expansion of the composite electrode particles to prevent the composite electrode particles from rupturing.

### BRIEF DESCRIPTION OF THE DRAWINGS

FIG. 1 is a steps flow diagram showing the process of the present invention.

FIG. 2 is a steps flow diagram showing the processes of the step 500 to step 530 of the present invention.

FIG. 3 is a steps flow diagram showing the processes of the step 540 to step 550 of the present invention.

FIG. 4 is a cross-section view showing the structure of the composite electrode particle of the present invention.

FIG. 5 is a schematic view showing the porous carbon particle of the present invention.

FIG. 6 is a schematic view showing the full structure and a partial structure of the composite electrode particle of the present invention.

FIG. 7 is a schematic view showing the silicon particles and the silicon oxide layer of the present invention.

FIG. 8 is a schematic view showing the carbon-nanotubes-coated composite electrode particle of the present invention.

FIG. 9 is a schematic view showing an application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

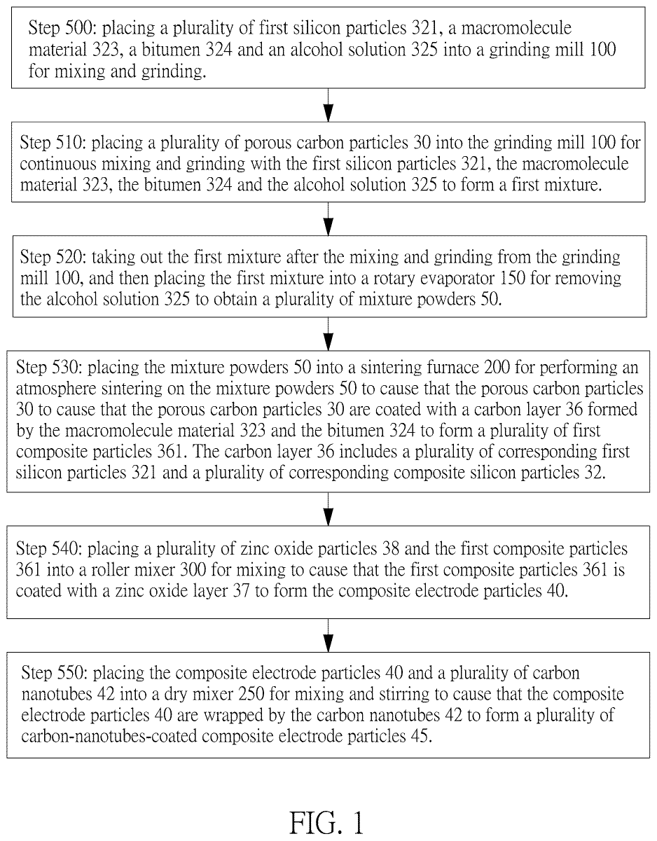

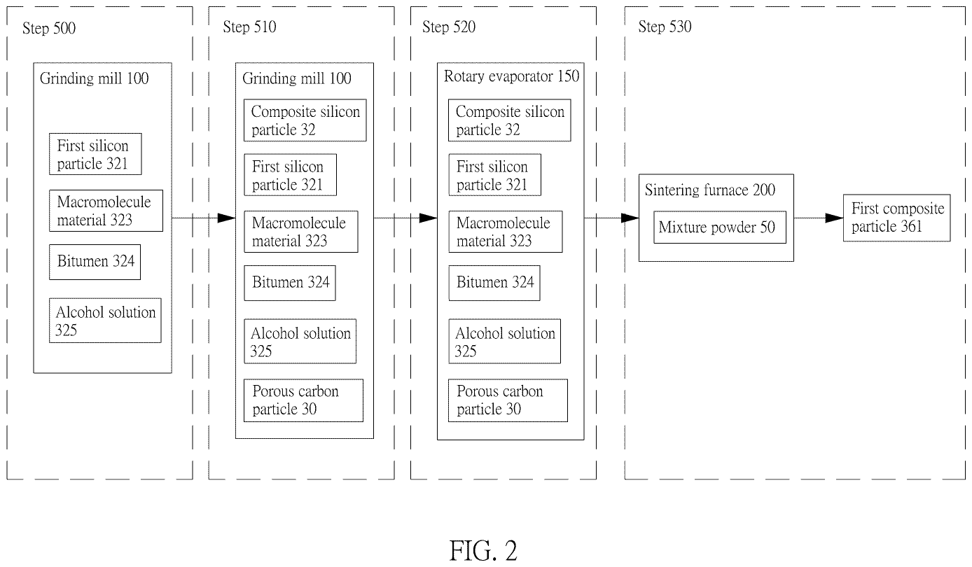

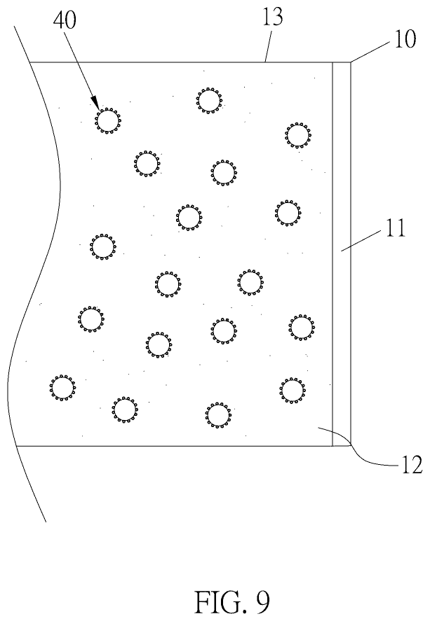

With reference to FIGS. 1 to 9, the present invention provides a method for manufacturing composite electrode particles 40 coated with a granular silicon structure, a carbon layer and zinc oxide. The composite electrode particles 40 are used in a negative (−) electrode 10 of a solid-state or semi-solid battery. Referring to FIG. 9, the negative electrode 10 includes a negative electrode substrate 11 for carrying the material of the negative electrode 10, and a negative electrode slurry layer 13 coated on the negative electrode substrate 11. The negative electrode slurry layer 13 includes a plurality of composite electrode particles 40 and a negative electrode slurry 12 having a binder. A weight percentage of the composite electrode particles 40 in the negative electrode slurry layer 13 is 90 wt %˜99 wt %. A size of each of the composite electrode particles 40 is 5 μm to 12 μm.

Referring to FIGS. 1 to 3, the method of the present invention comprises the following steps of:

Step 500: placing a plurality of first silicon particles 321, a macromolecule material 323, a bitumen 324 and an alcohol solution 325 into a grinding mill 100 for mixing and grinding. The grinding mill 100 is a wet grinding mill. A grinding time of the grinding mill 100 is 4˜6 hours. A grinding rotation speed of the grinding mill 100 is 2600 rpm˜3000 rpm. Preferably, the alcohol solution 325 is formed by isopropyl alcohol or ethanol. The macromolecule material 323 is selected from at least one of sodium dodecyl sulfate (SDS), polyvinylpyrrolidone (PVP), carboxymethyl cellulose (CMC), linear macromolecule containing carboxyl groups, and phenol-formaldehyde resin (PF).

Before the mixing and grinding of the step 500, a ratio of a weight of the first silicon particles 321, a weight of the macromolecule material 323 and a weight of the bitumen 324 is 80˜90:2˜10:2˜10. A ratio of a weight of a solid formed by the first silicon particles 321, the macromolecule material 323 and the bitumen 324 and a weight of the alcohol solution 325 is 4:6.

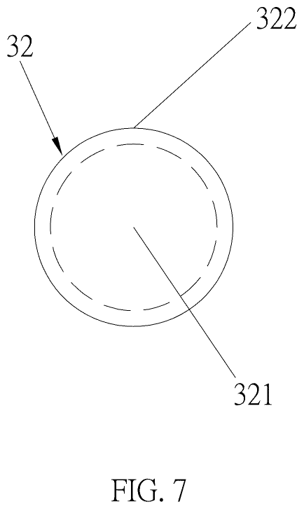

Referring to FIG. 7, in the mixing and grinding of the grinding mill 100, a part of the first silicon particles 321 performs a disproportionation to form a plurality of composite silicon particles 32. Each of the composite silicon particles 32 includes a respective one first silicon particle 321 and a silicon oxide layer 322 formed by SiOₓ, wherein 0<x≤2. The silicon oxide layer 322 is formed through the disproportionation and is coated on an outer surface of the respective first silicon particle 321. A size of each of the composite silicon particles 32 is 10 nm to 30 nm. A thickness of the silicon oxide layer 322 is less than 3 nm.

The conductivity of the silicon oxide layer 322 is lower than that of the first silicon particle 321. When the lithium ions pass the first silicon particles 321 to expand the size of the first silicon particles 321, the huge size expansion of the first silicon particles 321 will damage the final produced electrode particle. The coefficient of thermal expansion of is lower than that of the silicon oxide layer 322 and the binding ability of the silicon oxide layer 322 is better than that of the first silicon particle 321, which inhibits the expansion of the composite electrode particle 40 to prevent the produced composite electrode particle from rupturing.

Step 510: placing a plurality of porous carbon particles 30 into the grinding mill 100 for continuous mixing and grinding with the first silicon particles 321, the macromolecule material 323, the bitumen 324 and the alcohol solution 325 to form a first mixture. A mixing and grinding time of the grinding mill 100 is 0.5˜2 hours. A grinding rotation speed of the grinding mill 100 is 1800 rpm˜2200 rpm.

A ratio of a total weight of the porous carbon particles 30 and a total weight of the first silicon particle 321 is 80˜95:5˜20. Each of the porous carbon particles 30 has a plurality of holes 31 to receive the expanded first silicon particles 321. After the mixing and grinding of the step 510, a size of each of the porous carbon particles 30 is 5 μm to 10 μm.

Step 520: taking out the first mixture after the mixing and grinding from the grinding mill 100, and then placing the first mixture into a rotary evaporator 150 for removing the alcohol solution 325 to obtain a plurality of mixture powders 50. The rotary evaporator 150 is a water bath assisted rotary evaporator and a water bath temperature of the rotary evaporator 150 is 20° C.˜45° C.

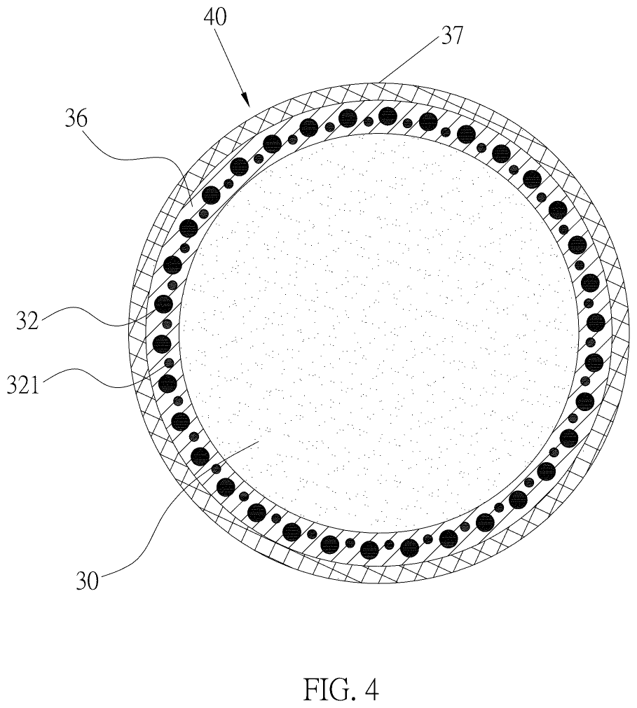

Step 530: placing the mixture powders 50 into a sintering furnace 200 for performing an atmosphere sintering on the mixture powders 50 to cause that the porous carbon particles 30 forms a plurality of first composite particles 361. A sintering temperature of the sintering furnace 200 is 980° C.˜1100° C. A sintering time of the sintering furnace 200 is 6˜8 hours. Referring to FIGS. 4 to 6, in the atmosphere sintering, an outer surface of each of the porous carbon particles 30 is coated with a carbon layer 36 formed by the macromolecule material 323 and the bitumen 324. The carbon layer 36 includes a plurality of corresponding first silicon particles 321 and a plurality of corresponding composite silicon particles 32. Each of the porous carbon particles 30 coated with the carbon layer 36 forms a respective one first composite particle 361. Excess non-carbon elements are removed by the atmosphere sintering. The atmosphere sintering may be a sintering under an atmosphere formed by argon (Ar), or a sintering under an atmosphere formed by nitrogen (N2). The macromolecule material 323 and the bitumen 324 assist each of the first silicon particles 321 and the composite silicon particles 32 in attaching to a corresponding porous carbon particle 30.

The first silicon particles 321 and the composite silicon particles 32 on each of the first composite particles 361 form a discontinuous structure, wherein in each of the first composite particles 361, the first silicon particles 321 and the composite silicon particles 32 on an outer side of the corresponding carbon layer 36 form an island-shaped structure having plural protruded portions, the first silicon particles 321 and the composite silicon particles 32 on an inner side of the corresponding carbon layer 36 are attached on the outer surface of the corresponding porous carbon particle 30, and the first silicon particles 321 and the composite silicon particles 32 between the outer side and the inner side of the corresponding carbon layer 36 are suspended in the corresponding carbon layer 36 without contacting the corresponding porous carbon particle 30.

The carbon layer 36 has a high conductivity and serves to inhibit an expansion of the produced electrode particle to prevent the electrode particle from rupturing due to a volumetric expansion when the lithium ions fill on the electrode particle.

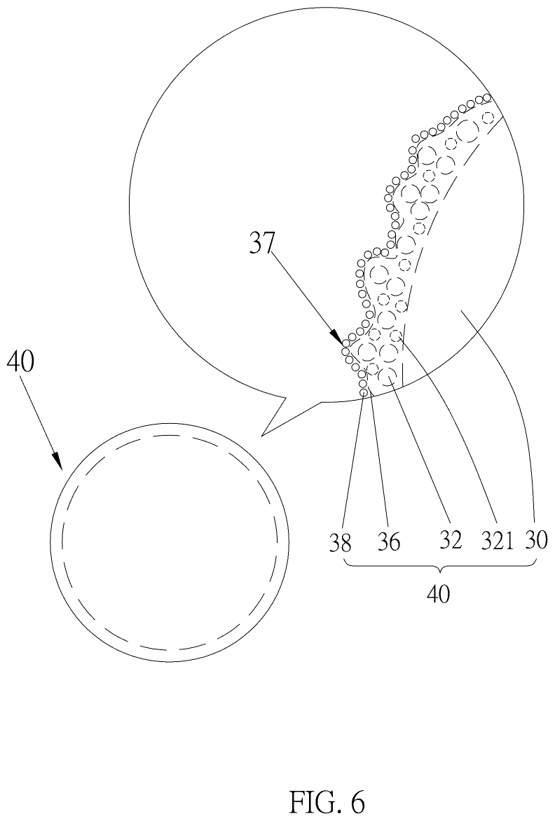

Step 540: placing a plurality of zinc oxide particles 38 and the first composite particles 361 into a roller mixer 300 for mixing to cause that an outer surface of each of the first composite particles 361 is coated with a zinc oxide layer 37 formed by the zinc oxide particles 38. The first composite particles 361 coated with the zinc oxide layer 37 form the composite electrode particles 40 of the present invention. Referring to FIGS. 4 and 6, the zinc oxide particles 38 on each of the first composite particles 361 form an island-shaped structure having plural protruded portions. A mixing time of the roller mixer 300 is 0.5˜2 hours. A rotation speed of the roller mixer 300 is 200 rpm˜350 rpm. The roller mixer 300 has a plurality of zirconium balls. A filling ratio of the zirconium balls is 30%˜50%, which is a ratio of a total volume of the zirconium balls to a mixing volume of the roller mixer 300. A size of each of the zirconium balls is 1.2 mm˜2 mm.

The zinc oxide layer 37 has a high conductivity and has a specific ductility identical to that of metals. When the lithium ions fill the first silicon particles 321 and expand the size of the first silicon particles 321, the zinc oxide layer 37 serves to protect the structure inside by the high ductility and to keep an integrity of the composite electrode particle 40.

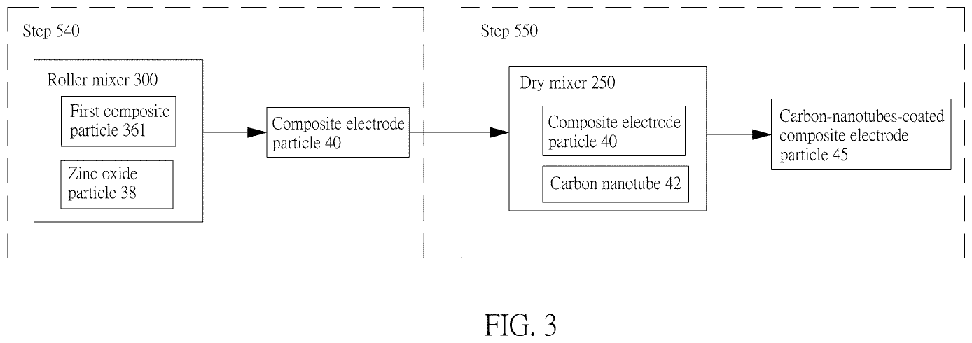

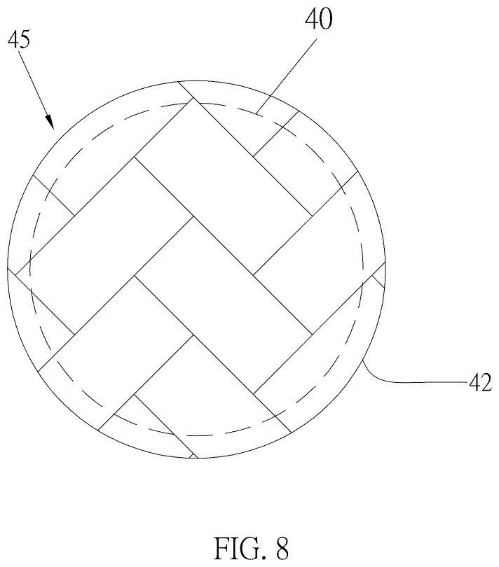

Referring to FIGS. 3 and 8, the method of the present invention further includes the following step of:

Step 550: placing the composite electrode particles 40 and a plurality of carbon nanotubes 42 into a dry mixer 250 for mixing and stirring to cause that an outer side of each of composite electrode particles 40 is wrapped by the carbon nanotubes 42. The composite electrode particles 40 wrapped with the carbon nanotubes 42 form a plurality of carbon-nanotubes-coated composite electrode particles 45. A size of each of the carbon nanotubes 42 is less than 5 μm. In each of the carbon-nanotubes-coated composite electrode particle 45, a ratio of a weight of the carbon nanotubes 42 and a weight of the composite electrode particle 40 is 1:99 to 0.2:99.8.

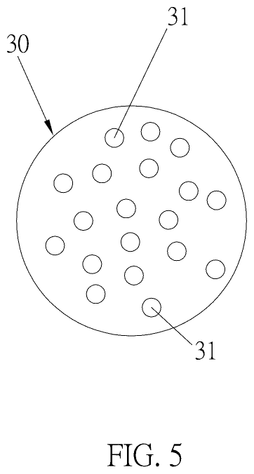

The carbon nanotubes 42 have a high conductivity. Each of carbon-nanotubes-coated composite electrode particles 45 has a yarn-ball-like structure (as shown in FIG. 5). The carbon nanotubes 42 serve to enhance the electrical conductivity to cause that the electrons can be conducted on the composite electrode particle 40. The carbon nanotubes 42 further serve to conducting the lithium ions to cause that the lithium ions can be conducted between different composite electrode particles 40 in the electrode, which increases the electrical conductivity and ion conductivity of the electrode.

The advantages of the present invention are that the carbon layer with the silicon particles is coated on the outer surface of the porous carbon particle. The silicon particles coated with the silicon oxide layer has a lower coefficient of thermal expansion and has a high binding ability, which inhibits the expansion of the composite electrode particle to prevent the composite electrode particle from rupturing. The carbon layer has a high conductivity and serves to inhibit an expansion of the composite electrode particle to prevent the composite electrode particle from rupturing due to a volumetric expansion when the lithium ions fill on the composite electrode particle. The outer side of the carbon layer is further coated with the zinc oxide layer which has a high conductivity and has the ductility identical to that of metals. When the lithium ions fill the silicon particles and expand the size of the silicon particles, the zinc oxide layer serves to protect the structure inside by the high ductility. As a result, by above multi-layer coating structure, the breakage rate of composite electrode particle can be greatly reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing composite electrode particles coated with a granular silicon structure, a carbon layer and zinc oxide comprising the steps of:
step A: placing a plurality of first silicon particles, a macromolecule material, a bitumen and an alcohol solution into a grinding mill for mixing and grinding; wherein in the mixing and grinding of the grinding mill, a part of the first silicon particles performs a disproportionation to form a plurality of composite silicon particles; each of the composite silicon particles includes a respective one first silicon particle and a silicon oxide layer formed by SiOₓ, wherein 0<x≤2; and the silicon oxide layer is formed through the disproportionation and is coated on an outer surface of the respective first silicon particle;
step B: placing a plurality of porous carbon particles into the grinding mill for continuous mixing and grinding with the first silicon particles, the macromolecule material, the bitumen and the alcohol solution to form a first mixture; and wherein each of the porous carbon particles has a plurality of holes to receive the first silicon particles expanded;
step C: taking out the first mixture after the mixing and grinding from the grinding mill, and then placing the first mixture into a rotary evaporator for removing the alcohol solution to obtain a plurality of mixture powders;
step D: placing the mixture powders into a sintering furnace for performing an atmosphere sintering on the mixture powders to cause that the porous carbon particles forms a plurality of first composite particles; wherein in the atmosphere sintering, an outer surface of each of the porous carbon particles is coated with the carbon layer formed by the macromolecule material and the bitumen; the carbon layer includes a plurality of corresponding first silicon particles and a plurality of corresponding composite silicon particles; each of the porous carbon particles coated with the carbon layer forms a respective one first composite particle; the first silicon particles and the composite silicon particles on each of the first composite particles form a discontinuous structure, wherein in each of the first composite particles, the first silicon particles and the composite silicon particles on an outer side of the corresponding carbon layer form an island-shaped structure having plural protruded portions, the first silicon particles and the composite silicon particles on an inner side of the corresponding carbon layer are attached on the outer surface of the corresponding porous carbon particle, and the first silicon particles and the composite silicon particles between the outer side and the inner side of the corresponding carbon layer are suspended in the corresponding carbon layer without contacting the corresponding porous carbon particle;
step E: placing a plurality of zinc oxide particles and the first composite particles into a roller mixer for mixing to cause that an outer surface of each of the first composite particles is coated with a zinc oxide layer formed by the zinc oxide particles; wherein the first composite particles coated with the zinc oxide layer form the composite electrode particles; and the zinc oxide particles on each of the first composite particles form an island-shaped structure having plural protruded portions; and
wherein the silicon oxide layer serves to inhibit an expansion of the composite electrode particles to prevent the composite electrode particles from rupturing.

2. The method for manufacturing the composite electrode particles coated with the granular silicon structure, the carbon layer and the zinc oxide as claimed in claim 1, wherein a size of each of the composite electrode particles is 5 μm to 12 μm.

3. The method for manufacturing the composite electrode particles coated with the granular silicon structure, the carbon layer and the zinc oxide as claimed in claim 1, wherein in the step A, the grinding mill is a wet grinding mill; a grinding time of the grinding mill is 4˜6 hours; and a grinding rotation speed of the grinding mill is 2600 rpm˜3000 rpm.

4. The method for manufacturing the composite electrode particles coated with the granular silicon structure, the carbon layer and the zinc oxide as claimed in claim 1, wherein the alcohol solution is formed by isopropyl alcohol or ethanol.

5. The method for manufacturing the composite electrode particles coated with the granular silicon structure, the carbon layer and the zinc oxide as claimed in claim 1, wherein the macromolecule material is selected from at least one of sodium dodecyl sulfate (SDS), polyvinylpyrrolidone (PVP), carboxymethyl cellulose (CMC), linear macromolecule containing carboxyl groups, and phenol-formaldehyde resin (PF).

6. The method for manufacturing the composite electrode particles coated with the granular silicon structure, the carbon layer and the zinc oxide as claimed in claim 1, wherein before the mixing and grinding of the step A, a ratio of a weight of the first silicon particles, a weight of the macromolecule material and a weight of the bitumen is 80˜90:2˜10:2˜10.

7. The method for manufacturing the composite electrode particles coated with the granular silicon structure, the carbon layer and the zinc oxide as claimed in claim 1, wherein before the mixing and grinding of the step A, a ratio of a weight of a solid formed by the first silicon particles, the macromolecule material and the bitumen and a weight of the alcohol solution is 4:6.

8. The method for manufacturing the composite electrode particles coated with the granular silicon structure, the carbon layer and the zinc oxide as claimed in claim 1, wherein after the mixing and grinding of the step A, a size of each of the composite silicon particles is 10 nm to 30 nm;
and a thickness of the silicon oxide layer is less than 3 nm.

9. The method for manufacturing the composite electrode particles coated with the granular silicon structure, the carbon layer and the zinc oxide as claimed in claim 1, wherein in the step B, a mixing and grinding time of the grinding mill is 0.5˜2 hours; and a grinding rotation speed of the grinding mill is 1800 rpm˜2200 rpm.

10. The method for manufacturing the composite electrode particles coated with the granular silicon structure, the carbon layer and the zinc oxide as claimed in claim 1, wherein in the step B, a ratio of a total weight of the porous carbon particles and a total weight of the first silicon particle is 80˜95:5˜20.

11. The method for manufacturing the composite electrode particles coated with the granular silicon structure, the carbon layer and the zinc oxide as claimed in claim 1, wherein after the mixing and grinding of the step B, a size of each of the porous carbon particles is 5 μm to 10 μm.

12. The method for manufacturing the composite electrode particles coated with the granular silicon structure, the carbon layer and the zinc oxide as claimed in claim 1, wherein in the step D, a sintering temperature of the sintering furnace is 980° C.˜1100° C.; and a sintering time of the sintering furnace is 6˜8 hours.

13. The method for manufacturing the composite electrode particles coated with the granular silicon structure, the carbon layer and the zinc oxide as claimed in claim 1, wherein the atmosphere sintering is a sintering under an atmosphere formed by argon (Ar), or a sintering under an atmosphere formed by nitrogen (N2).

14. The method for manufacturing the composite electrode particles coated with the granular silicon structure, the carbon layer and the zinc oxide as claimed in claim 1, wherein in the step E, a mixing time of the roller mixer is 0.5˜2 hours; a rotation speed of the roller mixer is 200 rpm˜350 rpm; the roller mixer has a plurality of zirconium balls; a filling ratio of the zirconium balls is 30%˜50%, which is a ratio of a total volume of the zirconium balls to a mixing volume of the roller mixer; and a size of each of the zirconium balls is 1.2 mm˜2 mm.

15. The method for manufacturing the composite electrode particles coated with the granular silicon structure, the carbon layer and the zinc oxide as claimed in claim 1, further comprising the step of:
step F: placing the composite electrode particles and a plurality of carbon nanotubes into a dry mixer for mixing and stirring to cause that an outer side of each of composite electrode particles is wrapped by the carbon nanotubes; wherein the composite electrode particles wrapped with the carbon nanotubes form a plurality of carbon-nanotubes-coated composite electrode particles; and each of carbon-nanotubes-coated composite electrode particles has a yarn-ball-like structure.

16. The method for manufacturing the composite electrode particles coated with the granular silicon structure, the carbon layer and the zinc oxide as claimed in claim 15, wherein a size of each of the carbon nanotubes is less than 5 μm.

17. The method for manufacturing the composite electrode particles coated with the granular silicon structure, the carbon layer and the zinc oxide as claimed in claim 15, wherein in each of the carbon-nanotubes-coated composite electrode particle, a ratio of a weight of the carbon nanotubes and a weight of the composite electrode particle is 1:99 to 0.2:99.8.
